(19) United States
(12) Patent Application Publication
(10) Pub. No.: US 2002/0101448 A1
(43) Pub. Date: Aug. 1, 2002

(54) Generating a declarative user interface

(76) Inventor: Richard A. Sanderson, Pompano Beach, FL (US)

Correspondence Address: J. Rodman Steele, Jr., Akerman, Senterfitt & Eidson, P.A., Post Office Box 3188, West Palm Beach, FL, 33402-3188, US

(21) Appl. No.: 09/996,435

(22) Filed: Nov. 29, 2001

Related U.S. Application Data
(60) Provisional application No. 60/253,756, filed on Nov. 29, 2000.

(51) Int. Cl. G09G 5/00

(52) U.S. Cl. 345/762

(57) ABSTRACT

A declarative UI generator. The declarative UI generator can generate a complex UI through the transmission and interpretation of context specifying configuration and workflow data. While the configuration data can be used by the declarative UI generator to configure communicative links between content servers and one or more data sources, the workflow data can be used to describe tasks to be performed through the declarative UI. Based upon these tasks, the declarative UI generator can select suitable UI widgets and can arrange the UI widgets in the UI in order to accommodate the specified tasks.

### CROSS REFERENCE TO RELATED APPLICATIONS

This patent application claims priority under 35 U.S.C. § 11 9(e) to U.S. patent application Ser. No. 60/253,756, filed on Nov. 29, 2000, the contents of which are incorporated herein by reference.

### BACKGROUND OF THE INVENTION

1. Technical Field

This invention relates to the field of user interfaces and more particularly to the dynamic declaration and generation of a user interface.

2. Description of the Related Art

Software developers often confront many difficulties in producing a presentation layer for network distributed applications, such as Web applications. Web applications typically utilize an n-tier architecture. Specifically, the n-tier architecture generally can include application business application logic stored in one or more servers or layer of servers. In that configuration, the application user interface (UI) can be stored in the client, while the application data can remain stored in database servers.

When implementing software in an n-tier architecture, and particularly when designing the application UI, the software developer can be challenged with a generally conflicting set of choices: provide a powerful interactive UI, or provide an HTML-based UI displayable in a Web browser. If the software developer chooses to provide a powerful, interactive UI, a customized client application will be required for each associated server side application further requiring the maintenance of multiple applications on numerous desktops through an enterprise. By comparison, if the software developer chooses to provide an HTML-based UI, the maintenance overhead can be avoided, but the HTML-based UI will lack the interactivity and power for which users have become accustomed.

Recognizing this apparent paradox, several intermediate presentation layer solutions have been implemented. Examples of these intermediate solutions include applets, ActiveX Controls, DHTML, JSP, and ASP pages. Still, these intermediate solutions produce unwanted consequences including the necessity of large downloads resulting in increased network bandwidth requirements, undue server side processing, security lapses, added complexity and an skill level required of the software developers, to name a few.

For example, Java applets have been effective in providing a development platform upon which complex UIs can be developed. In particular, as the Java programming language was intentionally designed to support network deployed applications, Java applets have been able to facilitate the development of the UI in network-deployed applications. Morever, inasmuch as Java applets can be invoked through a Web page, Java applets have proven to be a suitable platform upon which the development of Web application UI can be based. Still, although Java applets can deliver a UI that is much more robust than what can be attained through the use of HTML markup, applets have failed to achieve widespread use in web site designs for several reasons.

First, applets must be delivered to the client every time a user requests the Web page hosting the applet. Second, applets are generally much larger in size than typical markup. Hence, the communications bandwidth through which the applets are deployed must be increased to support transmission of the applets. Moreover, the applets are not usable until the entire applet has been downloaded. Thus, users can be subjected to delays when interfacing with an applet. Third, creating Java-based applets still requires skilled Java programmers. In consequence, the cost of building Java-based applets often will exceed that of creating HTML based markup. Finally, Java applets operate in a constrained environment referred to as the Java “sandbox”. In consequence, when executing within the constraints imposed by the Java runtime environment, applets can access neither the user's computer nor any host other than the source computer hosting the applet.

As an alternative to Java applets, several methods have been documented in which a client application can read UI meta-information and generate an interactive UI based thereon. Examples include the Bean Markup Language™ (BML) and the User Interface Markup Language™ (UIML). In both BML and UIML, a schema with given semantics can be produced. In particular, the schema can specify UI widgets and the properties thereof, including the business logic with which target UI widgets can be associated. An application can provide this schema to a UI generation module that can instantiate UI widgets based upon that schema. Both BML and UIML relate exclusively to the UI, however, and cannot account for the more complex processing required of the more dynamic UIs necessitated by modern network-deployed applications.

### SUMMARY OF THE INVENTION

The present invention is a declarative UI generation method which overcomes the deficiencies of the prior art. Specifically, a declarative UI generator which has been configured to perform the method of the invention can provide the complex UI often necessary for user-interactions with complex network deployed applications. Yet, the declarative UI generator does not require the extensive programming typically associated with scripts and applets. Furthermore, the declarative UI generator is not inhibited by the resource limitations associated with the “Java sandbox”. Similarly, the declarative UI generator does not required substantial network bandwidth as would be the case in the exchange of static markup, such as HTML.

Rather, in accordance with the inventive arrangements, a declarative UI generator can generate a complex UI through the transmission and interpretation of context specifying configuration and workflow data. While the configuration data can be used by the declarative UI generator to configure communicative links between content servers and one or more data sources, the workflow data can be used to describe tasks to be performed through the declarative UI. Based upon these tasks, the declarative UI generator can select suitable UI widgets and can arrange the UI widgets in the UI in order to accommodate the specified tasks.

In one aspect of the invention, a declarative UI generation method can include parsing a workflow description; identifying in the workflow description at least one unit of work, each unit of work corresponding to a pre-configured computing process, and further identifying in the workflow description meta-information describing data to be accessed through the UI. Once identified, each unit of work can be associated with selected ones of the meta-information. Subsequently, the UI can be constructed based upon the identified unit of work and its associated meta-information. Alternatively, the UI can be constructed according to a view directive identified within the workflow description. In either case, however, the UI can accommodate the pre-configured computing process specified by the workflow description.

In a particular aspect of the present invention, a declarative UI method can include retrieving a context file from a markup server, parsing the context file and extracting configuration data, content specifications and at least one workflow description from the context file, selecting UI widgets and positioning the selected UI -widgets in the UI based upon the content specifications the workflow description, configuring the UI for user and data communications based on the configuration data; and, accepting user interaction through the configured UI.

In a further particular aspect of the present invention, a declarative UI method can include reserving a portion of an application UI; receiving content-based specifications and at least one workflow description from a content server, the content-based specifications specifying characteristics of content to be displayed in the reserved portion of the application UI and the at least one workflow description specifying permissible interactions with the content, selecting UI widgets based upon the specified characteristics; and, positioning the UI widgets in the reserved portion of the application UI according to the at least one workflow description.

Importantly, aside from the various methods of the invention, a declarative UI generator also can be provided. Specifically, a declarative UI generator can include a communicator communicatively linking the declarative UI generator to a content server; a parser configured to identify a workflow description within contextual content received from the content server; and, a UI widget factory for creating UI widgets based upon the workflow description. In particular, the UI generator can position the created UI widgets in a reserved portion of a content browser according to the workflow description.

Notably, the workflow description can specify at least one unit of work, the unit of work corresponding to a pre-configured computing process. Also, the workflow description can further specify meta-information describing data to be accessed through the declarative UI. Finally, the pre-configured computing process can include a computing process selected from the group consisting of collecting and storing user preferences, collecting and storing personal information, collecting and forwarding purchase information, and database query processing and presentation.

### BRIEF DESCRIPTION OF THE DRAWINGS

There are presently shown in the drawings embodiments which are presently preferred, it being understood, however, that the invention is not limited to the precise arrangements and instrumentalities shown, wherein:

FIG. 1 is a pictorial representation of a client-server computing environment for use in a system for dynamically generating an interactive user interface (UI);

FIG. 2 is a UML diagram illustrating an object-oriented data communications architecture in the client-server computing environment of FIG. 1;

FIG. 3 is a UML diagram illustrating an object-oriented system for providing client-server interaction in the client-server computing environment of FIG. 1; and,

FIGS. 4A-4B, taken together, are a flow chart illustrating a method of dynamically generating a UI in the client-server computing environment of FIG. 1.

### DETAILED DESCRIPTION OF THE INVENTION

The present invention is an apparatus, system and method for the generation of a declarative UI. Specifically, in the present invention a computer program residing in a computing device can generate a UI configured for interacting with data from a server-based application without having prior knowledge of the application. More particularly, in the present invention, the data to be displayed and accessed through the UI, in addition to the tasks which can be used to access and manipulate the data, can define the UI itself. As such, prior to receiving data to be displayed in the UI, the UI dynamically can receive contextual information which can define the type of data to be displayed in the UI and the tasks with which the data can be accessed and manipulated. Using the contextual information, the declarative UI can select and appropriately position those UI elements in order to accommodate the tasks in an appropriate context.

The present invention can be implemented in a data-driven declarative UI generator. The declarative UI generator can be a computer program that can execute either independently as a stand-alone application, or dependently through a content browser such as a Web browser. When implemented as a dependent application, the declarative UI generator can be a network distributable applet or a browser plug-in. Importantly, the declarative UI generator can dynamically generate a UI for interacting with disparate data without requiring the UI to contain executable explicit instructions directed specifically to the disparate data.

Additionally, in accordance with the present invention, the UI generator need not require the provisioning of additional information about the desired UI by the source of the disparate data. Thus, the UI generator can interact with arbitrary data and generate a suitable UI for that data based solely upon the data and the tasks with which the data can be accessed and manipulated. A user's computing device may automatically configure itself at runtime to create a UI that supports interaction with a server-based application without having prior knowledge of the server-based application.

Ideally, in accordance with the present invention, the declarative UI generator can communicate with disparate server-side applications, application servers, and databases and further can initiate user interaction. Importantly, the UI generator can utilize tasks that perform units of work such as querying, displaying information in header/detail format, or credit card processing to name a few. Tasks can be combined in a manner that creates a great varied number of permutations of possible applications. Tasks can be configured during initialization of the UI generator, preferably when the UI generator downloads a configuration file or a context file.

Configuration or context files can describe the following configuration aspects: a communications protocol and/or messaging mechanism expected by a server in communicating with the declarative UI generator; a content or data format expected by the server; a description of the data, data types, and data structures for transmission and display; workflow information describing tasks that can be performed through a declarative UI generated by the declarative UI generator; and support such as calendaring, scheduling, and other support functions that the declarative UI generator can provide to the tasks.

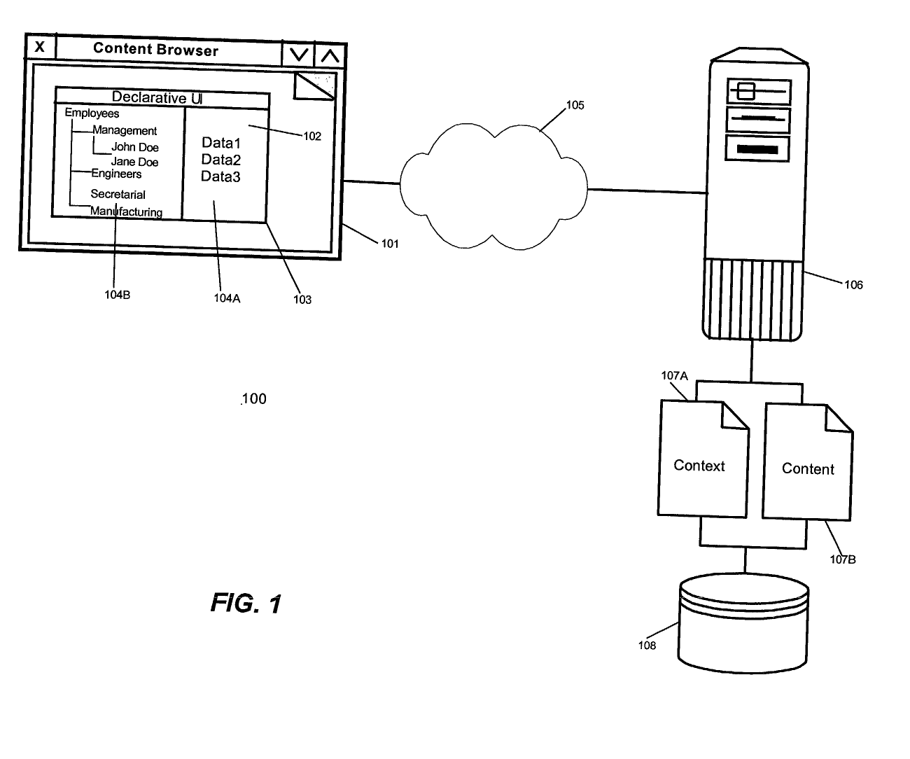

FIG. 1 illustrates a system for dynamically generating a declarative UI in an n-tier computing environment. The system 100 can include a content browser 101, a content server 106 and a computer communications network 105 communicatively linking the browser 101 to the server 106. A declarative UI generator 103 can be configured to cooperatively execute with the content browser 101. Notably, the content browser 101 can be any application suitable for decoding and displaying markup either in a desktop or handheld environment. Examples of markup include statements and instructions formulated in accordance with standardized general markup language (SGML), hypertext markup language (HTML), extended markup language (XML) and wireless markup language (WML). In one aspect of the invention, the content browser 101 is a Web browser for interpreting HTML compliant markup although the invention is not limited in this regard.

The declarative UI generator 103 can cooperatively execute with the content browser 101 in several ways. For instance, the UI generator 103 can be a plug-in to the content browser 101. Plug-in technology is a well-known technology which can facilitate the third-party extension of a content browser with native support for new data types and additional features. Plug-ins typically appear as additional capabilities of the browser, indistinguishable to the user from the baseline features. Still, the invention is not limited to a declarative UI generator cooperatively executing with a content browser. Rather, in another embodiment of the present invention, the declarative UI generator 103 can be a stand-alone application which can execute in the absence of a content browser.

In an embodiment of the invention in which the declarative UI generator 103 cooperatively executes with a content browser 101, the declarative UI generator 103 can become activated upon the retrieval from the content server 106 of markup 102 containing a trigger tag (not shown). More particularly, the trigger tag can be an embedded tag in the markup 102 which is recognizable by the content browser by virtue of extended features added by the plug-in. As such, when activated, the UI generator 103 can reserve a portion of the displayed markup 102 in which UI elements can be positioned by the declarative UI generator 103. Upon activation, the declarative UI generator 103 can retrieve configuration and initialization data contained in context 107A stored in fixed storage 108 in the content server 106.

More particularly, context 107A can contain contextual information relating to data to be displayed by the UI generator 103. Additionally, for the purpose of efficiency, context 107A also can include configuration and initialization data for facilitating the initialization and maintenance of a communications session between the UI generator 103 and the server 106. An XML document containing exemplary context is shown, for illustrative purposes only, in Appendix A. As shown in Appendix A, the configuration and initialization data in context 1 07A can specify the location of the server 106 and the manner in which the declarative UI generator 103 can communicate with the server 106, for instance by way of the HTTP protocol. Additionally, the configuration and specification data can establish the messaging mechanisms for transmitting content 107B between the server 106 and the declarative UI generator 103. Finally, the configuration and specification data can establish how the declarative UI generator 103 can request content 107B from the content server 106, for example by way of an object request broker.

Content 107B is an object that can translate data elements used by the declarative UI generator 103 to store data as specified and formatted by the content server 106. More particularly, content 107B represents structured data being transmitted from a source to a target and vice-versa. Content 107B can contain data elements that represent actual data, as well as requests or commands directed at the target. Thus, content 107B is an abstraction that allows various representations of data and data streams to be communicated between the declarative UI generator 103 and the content server 106. Notably, content 107B can take many forms, for example an HTML, SGML or XML document.

Context 107A can also be provided by the content server 106 to specify the structure and semantics of data to be communicated between the declarative UI generator 103 and the content server 106. Additionally, context 107A can specify the types of tasks to be performed with the data. Hence, context 107A can enable the declarative UI generator 103 to access data intelligently without having prior knowledge of the data. More particularly, the context 107A can eliminate the need to provide specific program instructions for handling the data. Rather, by examining the context 107A, the declarative UI generator 103 can identify the types of data elements to be displayed in the declarative UI generator 103, the interrelationship between each data element, and the types of tasks to be performed with the data elements through the declarative UI generator 103. In consequence, as shown in FIG. 1 for exemplary purposes only, suitable UI elements 104A, 104B can be selected, initialized and displayed in the UI generator 103 such that the selected UI elements 104A, 104B are consonant with the types of data elements to be displayed therein.

Advantageously, when implemented using the Java programming language, a UI generator in accordance with the inventive arrangements can provide the above-referenced benefits of a Java applet without the corresponding drawbacks associated with the Java security sandbox. Specifically, as a plug-in to the browser and not an applet, the declarative UI generator 103 is not restricted to the security sandbox imposed upon Java applets executing in a browser. In consequence, declarative UI generator 103 can interact with a client-side file system, for example to store preferences, or personal information such as credit card data. Also, the declarative UI generator 103 can concurrently connect to multiple servers, particularly Web sites.

Significantly, the declarative UI generator 103 of the present invention can reduce the bandwidth required for client-server interaction as a result of a lower volume of data required to provide a dynamically changing UI. Specifically, the server need not transmit new UI interface elements each time a new UI is required to appropriately display disparate data. Rather, only a specification of the disparate data and the types of tasks with which the data can be accessed and manipulated need be transmitted from the server 106 to the declarative UI generator 103.

Finally, by positioning the declarative UI generator 103 in the client rather than the content server 106, the declarative UI generator 103 and not the content server 106 need maintain the state of an on-going transaction. Moreover, by providing a declarative UI generator 103 which resides in the client, computer programmers, particularly Web site developers, need not develop source code in order to deploy the declarative UI generator 103. Rather, Web site developers need only provide a content specification to the declarative UI generator 103 specifying the type of data to be displayed in the dynamically generated UI and the tasks with which the data can be accessed and manipulated through the dynamically generated UI.

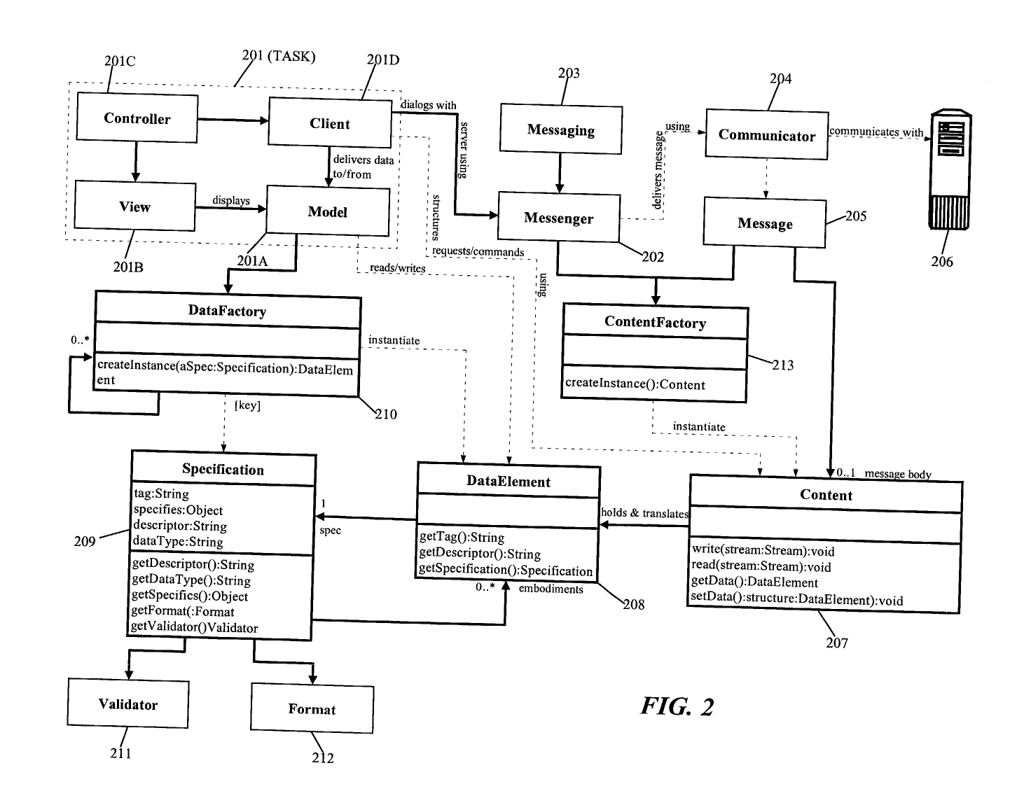

FIG. 2 is a UML diagram illustrating an object-oriented implementation of a system 200 for dynamically generating a declarative UI. The system 200 can include a task 201. A task 201 is a self-contained logical module that performs a specific kind of interaction with the user, or otherwise anon-visual process. For instance, each task 201 can provide access to data presented in the UI 200. Moreover, the task 201 can provide means for manipulating data presented in the UI 200. Examples of tasks include a Sales Task that can conduct a sales transaction, or a List Editor task that can query, display, edit, add, and delete objects from a list of similar objects. Notably, a task 201 can operate in the context of a content browser which has, concurrently operating therewith, a declarative UI generator configured in accordance with the inventive arrangements.

In one aspect of the present invention, each task specified in a context can be composed of four primary elements in a Model-View-Controller-Client (MVCC) architecture. An MVCC architecture can include a controller for initiating and responding to events associated with the task 201. The controller can be an object that ties together one model, view, and client. An MVCC architecture further can include a model for storing data acting as the subject matter of the task 201. The model further can provide the behavior for UI-related business logic associated with the data. In other words, the model can be an object that encapsulates the client-side representations of server-side business objects.

For a specific task, the model is usually inferred during the data-mapping phase. The MVCC architecture also can include a view. The view can provide the UI representation and data entry mechanism for the data stored in the model. Views can be objects that represent visual properties, labels, and controls representing selection lists, tables, trees, etc. Finally, the MVCC architecture can include a client. The client can populate the model with the data. Also, the client can encapsulate the server-side business logic associated with the subject matter represented by the model. Notably, in the MVCC architecture, the client is responsible for all interaction with the server 206. The clients can also be viewed as objects that provide an exchange mechanism between the server and a specific model's specific task

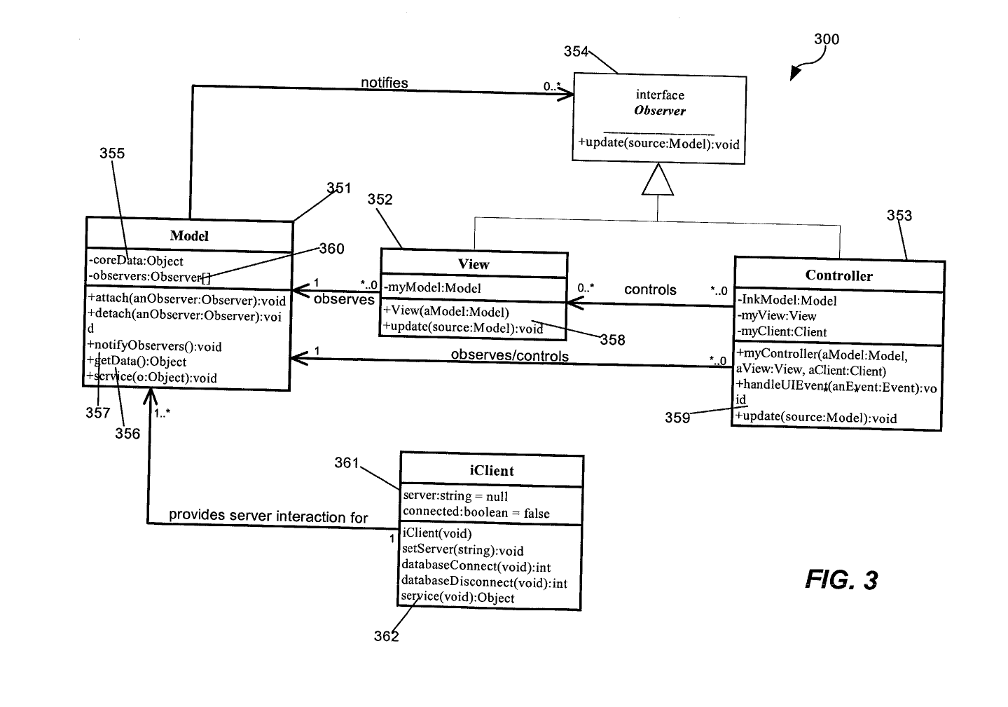

As shown in the UML diagram of FIG. 3, the components included in an MVCC architecture 300 can include at least one model component 355, at least one view component 352, at least one controller component 353 corresponding to the view component 352, and at least one client component 361 corresponding to the controller component 353. A change propagation mechanism 354, for example an implementation of the well-known observer pattern, can further be provided in order to maintain a registry 360 of dependent view and controller components 352, 353 within the model 351. The model 351 encapsulates core data and functionality. The model is independent of specific output representations or input behavior. The view component 352 displays information to the user. A view component obtains the data it displays from the model 351 and it should be understood that there can be mulitple views of the model.

Each view has an associated controller component 353. Controllers receive input, usually as events that denote mouse movement, activation of mouse buttons, keyboard input or other input such as input resulting from voice recognition or touch screen translation. Events are translated to service requests, which are sent either to the model or to the view. The user interacts with the system solely via controllers. Changes to the state of the model component 351 can trigger the change-propagation mechanism 354. Specifically, view components 352 and selected controller components 353 can register with the change-propagation mechanism 354 in order to express a need to be informed about changes to core data 355 stored within the model component 351. The change-propagation mechanism 354 can be the only link between the model component 351 and the view components 352 and controller components 353.

As shown in FIG. 3, the model component 351 can contain the functional core of a task. The model component 351 can encapsulate the core data 355 and can export procedures 356 that can perform UI related processing on the core data 355. Controller components 353 can call these procedures 356 on behalf of a user. The model component 351 also can provide functions 357 to access the core data 355 that can be used by view components 352 to acquire the core data 355 for display in a UI. In comparison, view components 352 can present the core data 355 to the user in a UI.

Different view components 352 can present the core data 355 of the model component 351 in different ways. Furthermore, each view component 352 preferably defines an update procedure 358 specified in the change-propagation mechanism 354 that can be activated by the change-propagation mechanism 354. When the update procedure 358 contained in the view component 352 is called, the view component 352 can retrieve from the model component 351 the current core data values 355 to be displayed in the UI. Subsequently, the view component 352 can display the core data 355 to the user in the UI.

Returning now to FIG. 2, each task 201 can communicate with a server 206 using a messenger 202. The messenger 202 can be an implementation of a messaging component 203. More particularly, a messenger 202 is an object which can encapsulate content 207 and can communicate such content 207 to and from the content server 206. An example of a messenger 202 is a JMS™ messenger which utilizes a messaging provider and messages compliant with the Java Messaging Service API.

Notably, the content 207 can be contained in a message 205. The messenger 202 can deliver messages 205 containing content 207 to the server 206 using a communicator object 204. The communicator object 204 is an object which can establish an actual communications session with the server 206 on behalf of a messenger 202. A typical communicator object 204 can include those methods necessary to open and close communications channels with the server 206 and for performing transmission and receipt of data through opened communications channels.

Content 207 are objects that can hold and translate data elements 208 used by the declarative UI generator to and from data streams as specified and formatted by the server 206. An example of such a data stream is an XML document. In the GUI generator, content 207 represents the transmission of a data element 208 from a source to a target and back again in the form of a response. Content 207 not only can contain data elements 208 that represent actual data, but also content 207 can contain data elements 208 that represent requests or commands directed at the target. Hence, content 207 is an abstraction that allows various representations of data and/or data streams to be communicated between two processes (i.e. a client and a server).

As shown in FIG. 2, data elements 208 can be defined which can be used by the GUI generator to hold data elements which are the subject of the interaction with the user through a dynamically generated UI. More particularly, a data element 208 can be organized in a tree-like fashion to support arbitrarily complex data. A data element 208 can be defined by a series of interfaces in an object-oriented inheritance hierarchy. The interfaces can be implemented in many ways as required, all the while supporting transmission of data from one implementation of a data element 208 to another without losing the semantics of the data elements contained therein. For example, one implementation of the a data element 208 might be well suited for interaction by user interface controls (widgets), while another implementation of a data element 208 may be designed for the most efficient transmission of the data through a network.

Content specifications 209 are provided to specify the structure and semantics of the data elements 208 while tasks 201 define the interactions for which the UI generator is being deployed. The content specifications 209, in combination with the tasks 201, enable the declarative UI generator to work with data in an intelligent fashion without prior knowledge of that data, and without programming code being written to effectively interact with that data. In particular, data elements 208 can be dynamically organized at run-time through the use of content specifications 209. Each specification 209 can contain attributes that define the behavior and allowable structure for the data element 208 specified therein. The exemplary context contained in the XML document shown in Appendix A includes content specifications. Still, the invention is not limited in regard to the method for encoding specifications. Rather, any suitable encoding method can suffice.

As shown in Appendix A, the specification 209 can contain a descriptor data member that can identify the semantic type of a data element 208. The specification 209 also can include a dataType data member. The dataType data member is an attribute that identifies the type of data element 208 that the specification 209 can represent. The dataType data member does not necessarily correspond to a programming level type or class, but rather to a domain specific business object type.

The specification 209 also can include a specifics data member. The specifics data member can be any object which contains additional information supplementing the dataType data member. For example, a DataType can be a composite data element (an element that is composed of other elements), while the specifics data member can indicate the kinds of elements that are legal aggregates of the composite. Finally, the specification 209 can include references to a validator object 211 and a format object 212. A validator object 211 is an object which can validate the value encapsulated by specified data elements 208. A format object 212 is an object which can specify a format for textually rendering the value of a specified data elements 208.

Each data element within a declarative UI generator data element 208 is given semantic meaning through the use of a tag. While tags are unique for each semantic idea, there may be many elements in a data element which have a common tag. The tag correlates to the descriptor property of the specification 209, which also can be unique among all specifications 209 within a given context. Tags are used by the declarative UI generator to associate data elements to a specification 209, data elements and/or specifications to a factory, and during the processing of data streams from the server, the identification of a specification that can be provided to a factory for the creation of a new data element. Accordingly, the specification 209 can include a tag data member which can uniquely identify a particular embodiment of a data element 208 corresponding to the specification 209.

Three types of object factories can be utilized during the operation of the declarative UI generator: a content factory 213, a data factory 210, and a widget factory (not shown). Content 207 can be generated by a content factory 213. A content factory 213 is an object that creates content objects 207 on behalf of a messenger 202. The content factory 213 can be defined as part of the configuration of the GUI generator and can be used by the messenger 202 to instantiate the appropriate implementation for each of the various types of content 207, as required by the declarative UI generator. Specifically, each time a messenger 202 needs to encapsulate a data element 208 for transmission in a message 205 to a server 206, the messenger 202 can request that the content factory 213 create an instance of a content object 207.

Specification objects 209 can be passed to a data factory 210 from which the factory can determine which class to instantiate to encapsulate a corresponding data element 208. The declarative UI generator of the present invention can include two types of data factories 210. One type, used by content objects 207, can produce data elements 208 suitable for transmission by the messenger 202. The other type, used by a UI task 201, can produce data elements 208 which are implemented in a fashion suitable for interaction with UI widgets.

The data factories 210 can be implemented as a dictionary of conventional factory objects configured to instantiate a single type of data element 208. The dictionary can be keyed on a specification 209 which correlates to the same data element. When the GUI generator requires a new instance of a data element 208, a specification 209 can be chosen based upon the tag of the required data element 208.

Subsequently, the specification 209 can be provided to the data factories in order to discover the correct data factory for use in producing the desired data element 208.

Finally, the widget factory (not shown) can use specifications 209 to determine which UI widget to produce in order to facilitate interaction between a user and the individual and composite data elements 208 displayed therein. In particular, a UI, including display panels and widgets for displaying and accepting user input for atomic data elements, can be generated dynamically by the UI generator. More particularly, the declarative UI generator can pass to the widget factory the content specifications 209 for particular data elements 208 to be displayed in the UI. The widget factory can be configured to create an appropriate UI control for the dataType provided by the specification 209. Additionally, the declarative UI generator can define high level views that specify an organization of the UI for pre-defined tasks 201 known by the declarative UI generator. That is, though the widget factory can create UI widgets consonant with specifications 209, the UI generator can arrange the created UI widgets according to the tasks 201 through which data displayed in the UI widgets can be accessed and manipulated.

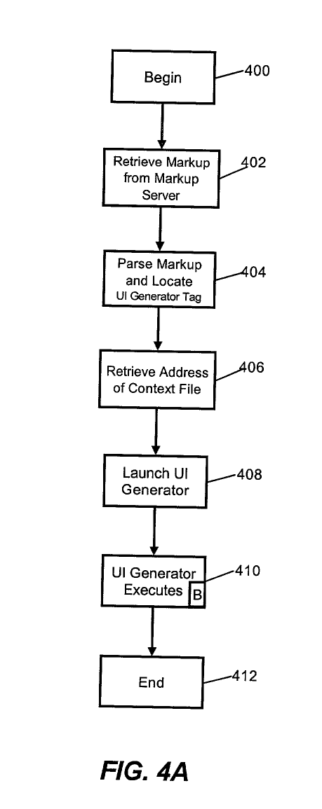

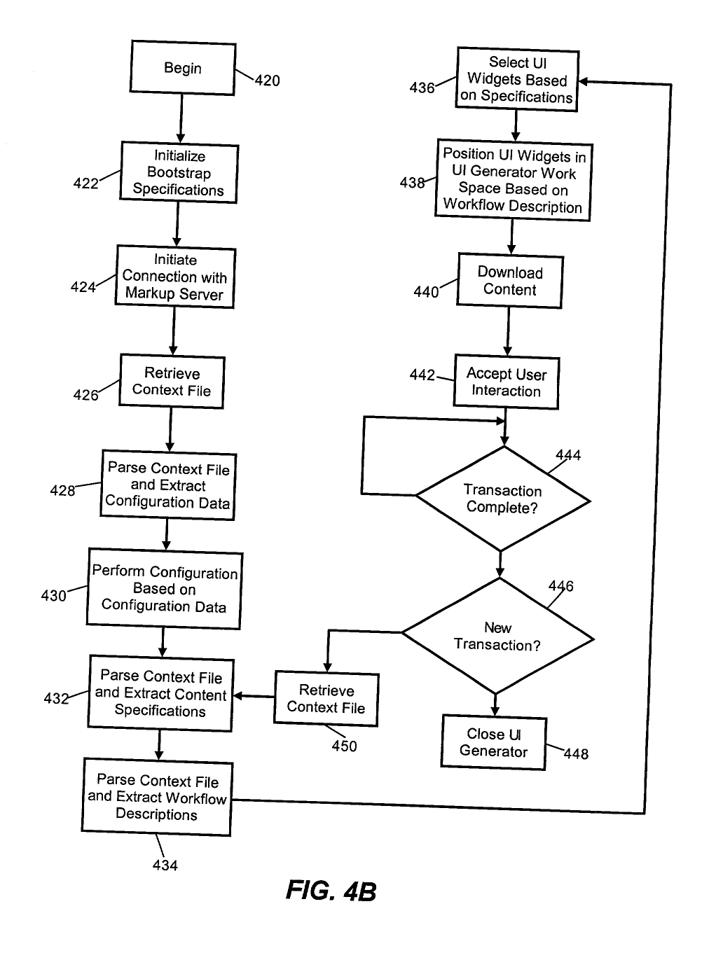

FIGS. 4A-4B, taken together, illustrate a process for dynamically generating a declarative UI through which a transaction can be performed in a client-server environment. Specifically, FIG. 4A illustrates a process for launching and executing a declarative UI generator session in a browser. FIG. 4B illustrates a process for initializing and configuring the declarative UI generator and for dynamically generating a declarative UI in accordance with content specifications and tasks relating to content to be displayed therein. Beginning in step 400 of FIG. 4A, a user can cause the browser to display markup by specifying the same. For instance, in a Web browser, the user can specify a Web page by providing a corresponding URL to the Web browser.

In response, in step 402, the browser can download the specified markup and in step 404, the browser can parse the markup in order to determine an appropriate method for rendering the markup. For example, in a Web browser, the Web browser can parse specified HTML in order to determine how to graphically render the Web page in the Web browser. In accordance with the present invention, a tag can be embedded in the markup. The tag can uniquely specify the UI generator and can reserve a portion of the browser display area for use by the UI provided by the UI generator. A parameter within the UI generator tag can provide the name and network location of a context file to be used by the UI generator both in performing a configuration routine and for dynamically generating a UI consonant with content specifications and tasks contained in the context file.

Accordingly, in step 406, the network location of the context file can be retrieved from the markup. Notably, the browser can be pre-configured to associate the UI generator tag with a UI generator plug-in. Hence, responsive to identifying the UI generator tag, in step 408 the UI generator plug-in can be launched. In turn, the UI generator plug-in can execute a Java Virtual Machine (JVM). Finally, in step 410, the UI generator application can execute within that JVM and the UI generator can assume control of the reserved portion of the browser display area.

Turning now to FIG. 4B, upon execution, in step 422, the UI generator can initialize using bootstrap specifications. The bootstrap specifications can include an internal set of meta-data objects which specify both data elements for use in messaging and content delivery, and published common data elements and commands which can be relied upon by those deploying the declarative UI generator for performing interactions therewith. More particularly, prior to establishing a communications session with a content server, the UI generator can create a data element for storing configuration information. The bootstrap specifications can be declared either in a file guaranteed to be present upon the initialization of the declarative UI generator, or otherwise declared programmatically within the source code of the declarative UI generator itself.

Subsequently, in step 424, the declarative UI generator can initiate a communications session with the server identified by the parsed name and network address contained in the originally received markup. Alternatively, the declarative UI generator can establish a communications session with the server previously specified by a previously supplied URL. In that case, the network address specifies only a location in a server specified by the previously supplied URL. In either case, in step 426 the context file can be retrieved.

The context file can specify configuration parameters for particular implementations for each abstracted technology service to be utilized during the communications session with the content server. The abstracted technology services can include the messenger, communicator, content and content factory, as shown in FIG. 2. In consequence, the configuration parameters permit the declarative UI generator to support varying technologies in a uniform manner. As such, the declarative UI generator can perform equivalently regardless of the technology in which the declarative UI generator is deployed. Furthermore, the underlying technology can change without affecting the function of the declarative UI generator.

The configuration process also can be used as a mechanism through which a server can specify operational parameters for conducting the communications session. Such operational parameters can include the location of periphery files, such as image files, that the declarative UI generator can access during the communications session and the general look and feel with which the declarative UI generator should conform during the communications session. Thus, in step 428, the declarative UI generator can parse the contents of the context file and can extract the configuration data therefrom.

Subsequently, the declarative UI generator can perform the configuration in step 430 based upon the settings, directives and parameters that are present in the configuration data. Specifically, in step 430 the declarative UI generator can establish the communication protocols for further dialog with the content server, establish the messaging mechanisms that will deliver and receive content to and from the server, establish the mechanism for retrieving content specifications from the server, set the high level UI look and feel parameters of the declarative UI generator, set the location of graphical images that may be used by the declarative UI generator, and set the series of that the UI generator will perform.

In step 432, the declarative UI generator can parse the context file and extract therefrom a set of content specifications. In step 434, the declarative UI generator can further parse the context file and extract therefrom one or more task descriptions. The task descriptions can be used to create task objects which describe both anticipated interactions (tasks) and data which can form the subject of the anticipated interactions between the declarative UI generator and the content server. In step 436, the declarative UI generator can use the content specification and task objects to dynamically generate a UI based on the described tasks. Specifically, in step 436, UI widgets can be created based upon the content specifications.

Moreover, the task objects can be used to determine how to arrange the created UI widgets. In particular, the UI generator can determine if a high-level view has been pre-specified for the particular task. Subsequently, in step 438 the UI generator can position selected UI widgets in the reserved area of the browser according to a pre-configured high-level view. If no high-level view has been specified, then the UI generator can position selected UI widgets in the reserved area of the browser according to pre-defined uniform widget positioning rules.

Subsequently, in step 440 the declarative UI generator can initiate a dialog with the content server, in a manner specified by the configuration, to request content suitable for user interaction, as specified by the tasks and content specifications. In step 442, the declarative UI generator initiates interaction with the user in a fashion defined by the tasks and the content. This interaction can include query processing, transactional interactions (such as shopping cart functions), and information processing (such as manipulation of the view of a geographic map). In step 444, the declarative UI generator communications session can continue through the completion of a transaction.

Notably, as the visual context changes for different stages of a transaction, the declarative UI generator can dynamically recreate such contexts so that there is no need to load multiple Web pages for each series of transactions. Moreover, multiple transactions are possible. As such, in step 446, if another transaction is to occur, a new context file can be retrieved in step 450. Subsequently, returning to step 432, a new set of content specifications and task descriptions can be extracted from the context file and the process can repeat therefrom. Otherwise, if no transactions remain, in step 448, the declarative UI generator and JVM can close, returning control of the reserved portion of the browser to the browser.

By using the various features of the present invention, a user would experience an interactive GUI with the look, feel, features, and functions of a desktop application, whereas traditional HTML would provide static pages of content going back and forth from a server for different page views. Furthermore, the present invention enables fast downloads because only the essential data is transmitted back and forth. No “pages” are created at the server and transmitted. In essence, features and functions of applets and the like can be delivered without long download times, high development costs, or potential security breaches.

APPENDIX A

<?xml version=“1.0” encoding=“UTF8”?>
<context name=“www.fourbit.com”>

<item name=“version”>0.7</item>
<item name=“imagePath”>images</item>
<item name=“launch”>taskManager</item>
<instance name=“messenger” class=“com.fourbit.fab.local.LocalMessenger”>

<item name=“server”>www.fourbit.com/example/fablet</item>

</instance>
<instance name=“communicator” class=“com.fourbit.fab.dc.messaging.HttpCommunicator”/>

<factory name=“content” class=“com.fourbit.tp.xml.XmlContentFactory”/>
<factory name=“data” class=“com.fourbit.fe.data.base.BasicFactories”/>
<factory name=“model” class=“com.fourbit.fab.ui.mvcc.BasicModelFactories”/>

</instance>
<!-- ROLE: role is a categorizer and forms a namespace-->
<role name=“task”>

<!-- TEMPLATE:

template is a specialized instance: they are
placed inside a “template” subcontext
if a template has a “class” attribute, an
instantiator will be created inside it.

-->
<template name=“taskManager” class=“com.fourbit.fab.ui.TaskManager”>

<item name=“launch”>wizard</item>

</template>
<template name=“editor” class=“com.fourbit.fab.ui.extent.SimpleExtentEditor”>

<specifics>

<item name=“extent”>extent.person</item>
<item name=“model”>person</item>

</specifics>

</template>

</role>
<template name=“extent.person” type=“extent”>

<item name=“type”>extent</item>
<item name=“description”>List of Persons</item>
<specifics>

<item name=“child”>person</item>

</specifics>

</template>
<template name=“person” type=“composite”>

<specifics>

<item name=“child”>name</item>
<item name=“child”>address</item>
<item name=“child”>dob</item>

</specifics>

</template>
<template name=“name” type=“text”/></template>
<template name=“address” type=“text”/></template>
<template name=“dob” type=text”/></template>

</context>

I claim:

1. A declarative user-interface (UI) method comprising the steps of:
parsing a workflow description;
identifying in the workflow description, at least one unit of work, each said unit of work corresponding to a pre-configured computing process;
further identifying in the workflow description meta-information describing data to be accessed through the UI;
associating said at least one unit of work with selected ones of said meta-information; and,
constructing the UI according to said association of said at least one unit of work and said meta-information, said construction of the UI accommodating said pre-configured computing process specified by said at least one unit of work.

2. The method of claim 1, further comprising the step of retrieving view directives, each said view directive specifying a particular arrangement of the UI.

3. A declarative UI generator comprising:
a communicator communicatively linking the declarative UI generator to a content server;
a parser configured to identify a workflow description within contextual content received from said content server, said workflow description specifying at least one unit of work, said unit of work corresponding to a pre-configured computing process, said workflow description further specifying meta-information describing data to be accessed through the declarative UI; and,
a UI widget factory for creating UI widgets based upon said workflow description;
the UI generator positioning said created UI widgets in a reserved portion of a content browser according to said workflow description.

4. The UI generator of claim 3, wherein the said pre-configured computing process comprises a computing process selected from the group consisting of collecting and storing user preferences, collecting and storing personal information, collecting and forwarding purchase information, and database query processing and presentation.

5. A declarative user-interface (UI) method comprising the steps of:
retrieving a context file from a markup server parsing the context file and extracting configuration data, content specifications and at least one workflow description from the context file;
selecting UI widgets and positioning said selected UI widgets in the UI based upon said content specifications said workflow description;
configuring the UI for user and data communications based on said configuration data; and, accepting user interaction through the configured UI.

6. A declarative user-interface (UI) method comprising the steps of:
reserving a portion of an application UI;
receiving content-based specifications and at least one workflow description from a content server, said content-based specifications specifying characteristics of content to be displayed in said reserved portion of said application UI and said at least one workflow description specifying permissible interactions with said content;
selecting UI widgets based upon said specified characteristics; and, positioning said UI widgets in said reserved portion of said application UI according to said at least one workflow description.

7. A machine readable storage having stored thereon a computer program for generating a declarative user-interface (UI), the computer program comprising a routine set of instructions for causing the machine to perform the steps of:
parsing a workflow description;
identifying in the workflow description, at least one unit of work, each said unit of work corresponding to a pre-configured computing process;
further identifying in the workflow description meta-information describing data to be accessed through the UI;
associating said at least one unit of work with selected ones of said meta-information; and,
constructing the UI according to said association of said at least one unit of work and said meta-information, said construction of the UI accommodating said pre-configured computing process specified by said at least one unit of work.

8. The machine readable storage of claim 7, further comprising the step of retrieving view directives, each said view directive specifying a particular arrangement of the UI.

9. A machine readable storage having stored thereon a computer program for generating a declarative user-interface (UI), the computer program comprising a routine set of instructions for causing the machine to perform the steps of:
retrieving a context file from a markup server
parsing the context file and extracting configuration data, content specifications and at least one workflow description from the context file;
selecting UI widgets and positioning said selected UI widgets in the UI based upon said content specifications said workflow description;
configuring the UI for user and data communications based on said configuration data; and, accepting user interaction through the configured UI.

10. A machine readable storage having stored thereon a computer program for generating a declarative user-interface (UI), the computer program comprising a routine set of instructions for causing the machine to perform the steps of:
reserving a portion of an application UI;
receiving content-based specifications and at least one workflow description from a content server, said content-based specifications specifying characteristics of content to be displayed in said reserved portion of said application UI and said at least one workflow description specifying permissible interactions with said content;
selecting UI widgets based upon said specified characteristics; and, positioning said UI widgets in said reserved portion of said application UI according to said at least one workflow description.
